(19) United States
(12) Patent Application Publication
(10) Pub. No.: US 2008/0317350 A1
(43) Pub. Date: Dec. 25, 2008

(54) PATTERN RECOGNITION APPARATUS AND METHOD

(76) Inventors: Osamu YAMAGUCHI, Kanagawa (JP); Tomokazu Kawahara, Kanagawa (JP); Masashi Nishiyama, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/139,245

(22) Filed: Jun. 13, 2008

(30) Foreign Application Priority Data
Jun. 14, 2007 (JP) 2007-157386

(51) Int. Cl. G06K 9/46; G06K 9/00

(52) U.S. Cl. 382/190; 382/118

(57) ABSTRACT

A image recognition apparatus includes a face input unit, an input subspace calculation unit, a dictionary subspace calculation unit, an eigenvalue calculation unit, a diagonal matrix generation unit, a transformation matrix calculation unit, a transformation unit, a similarity degree calculation unit, a recognition unit. The recognition unit, based on a similarity degrees calculated by the similarity degree calculation unit, recognizes which of a plurality of categories each of a plurality of input patterns belongs to.

### CROSS-REFERENCE TO RELATED APPLICATIONS

This application is based upon and claims the benefit of priority from the prior Japanese Patent Application No. 2007-157386, filed on Jun. 14, 2007; the entire contents of which are incorporated herein by reference.

### TECHNICAL FIELD

The present invention relates to a pattern recognition apparatus and method thereof.

### BACKGROUND OF THE INVENTION

A pattern recognition technology which, when an unknown pattern is input, identifies which of the category the pattern belongs to has been required in various fields. As one of methods for carrying out a pattern recognition with a high accuracy, Erkki Oja, Pattern Recognition and Subspace Method, Sangyo Tosho Publishing Co., Ltd., 1986 discloses a “subspace method.” In the subspace method, a comparison is made of similarities between one input pattern and subspaces (dictionaries) configured of patterns registered by category.

JP-A-2003-248826 (Kokai) discloses a “mutual subspace method.” In the mutual subspace method, a comparison is made of similarities between a plurality of input patterns, acquired from categories to be recognized, and dictionary patterns registered by category. A plurality of the dictionary patterns are registered in advance by category. In order to calculate the degree of similarity, input subspaces are generated from the plurality of input patterns, and dictionary subspaces are generated from the plurality of dictionary patterns. The number of dictionary subspaces prepared is the same as that of categories.

Each subspace is generated by transforming a pattern into a vector on a feature space, and utilizing a main component analysis. A similarity degree S is determined by Equation (1), based on an angle 304 formed by an input subspace 302 and dictionary subspace 303 on a feature space 301 of FIG. 3. In FIG. 3, reference number 305 denotes an origin of the feature space.

S=cos² θ₁ (1)

Herein, θ₁ represents the smallest angle of the angles formed by the subspaces. If the subspaces are completely identical, θ₁=0. As the similarity degree, a mean of T cos² θᵢ's (i=1 . . . T) or the like, other than cos² θ₁ may be used. cos² θᵢ can be obtained by solving eigenvalue problems as disclosed in JP-A-2003-248826 (Kokai).

Also, as a method of carrying out a feature extraction at a stage prior to the mutual subspace method, a feature extraction using an orthogonalization transformation (a whitening transformation) is carried out. An orthogonal mutual subspace method is disclosed in JP-A-2000-30065 (Kokai) and JP-A-2006-221479 (Kokai).

For example, as shown in FIG. 4, when angles formed by a dictionary subspace 402 of a category 1, a dictionary subspace 403 of a category 2, and a dictionary subspace 404 of a category 3 are small and similar to each other in a certain feature space 401, an input subspace which should be identified as the category 1 is erroneously identified as the category 2 or the category 3. In order to improve an identification accuracy, a method of linearly transforming the original feature space into a feature space 501 is effective. In the feature space 501, angles formed by a dictionary subspace 502 of a category 1, a dictionary subspace 503 of a category 2, and a dictionary subspace 504 of a category 3 are made as large as possible, as shown in FIG. 5.

In order to make the dictionary subspaces of the individual categories least similar to each other, that is, in order to set the similarity degrees between the dictionary subspaces to 0, the angles formed by the dictionary subspaces should be 90 degrees in accordance with the definition of Equation (1). In the orthogonal mutual subspace method, the identification accuracy is removed by linearly transforming the original feature space into the feature space in which the angles formed by the dictionary subspaces are orthogonal (90 degrees).

However, in the conventional methods, in a case where there are less categories to be identified, or in a case where a pattern has a strong nonlinearity, an identification capability is not improved by a transformation using an orthogonalization matrix.

For example, a recognition using a plurality of images is carried out by registering odd number rows regarding an image pattern in FIG. 8, and using even number rows as recognition data. In a case where a nonlinearity is strong in this way, when checking recognition rates as shown in FIG. 9, the recognition rate may fall short of those in a case of a constrained mutual subspace method (CMSM), which is one of the conventional methods, in which some parameters are changed, and is inferior to that of a basic mutual subspace method (MSM). It is conceivable that this results from a deterioration in a separation performance due to the transformation using the orthogonalization matrix.

The invention may provide a pattern recognition apparatus and method which can carry out a high precision pattern recognition in comparison with the conventional various mutual subspace methods.

### BRIEF SUMMARY OF THE INVENTION

According to an embodiment of the invention, the embodiment is a pattern recognition apparatus including an input subspace calculation unit which calculates input subspaces from a plurality of input patterns; a dictionary subspace calculation unit which calculates dictionary subspaces from dictionary patterns respectively corresponding to a plurality of categories; an eigenvalue calculation unit which, regarding a sum matrix of projection matrices concerning the dictionary subspaces, obtains a plurality of eigenvalues and a plurality of eigenvectors; a diagonal matrix generation unit which generates a diagonal matrix having diagonal components equivalent to a sequence in which at least one of the plurality of eigenvalues are replaced with 0; a transformation matrix calculation unit which, using the diagonal matrix and the plurality of eigenvectors, obtains a pseudo whitening matrix representing a linear transformation having a property of reducing a degree of similarity between the dictionary subspaces; a transformation unit which, using the pseudo whitening matrix, linearly transforms the input subspaces and the dictionary subspaces; a similarity calculation unit which calculates degrees of similarity between the linearly transformed input subspaces and the linearly transformed dictionary subspaces; and a recognition unit which, based on the similarity degrees, recognizes which of the plurality of categories each of the plurality of input patterns belongs to.

According to the embodiment of the invention, it being possible to carry out an identification of dictionary subspaces of registered individual categories by a feature space in which they are not similar, it is possible to carry out a more precise pattern recognition than with the mutual subspace method in the conventional methods.

### BRIEF DESCRIPTION OF THE DRAWINGS

FIG. 1 is a diagram showing a flowchart of a facial image recognition apparatus of a first embodiment of the invention;

FIG. 2 is a block diagram of the facial image recognition apparatus of the first embodiment;

FIG. 3 is a view showing a concept of a mutual subspace method;

FIG. 4 shows an example in which subspaces are similar on a feature space;

FIG. 5 shows an example in which no subspaces are similar on the feature space;

FIG. 6 is a diagram showing a flowchart of an orthogonalization matrix generation by a pseudo whitening matrix generation apparatus of a second embodiment;

FIG. 7 is a block diagram of the pseudo whitening matrix generation apparatus of the second embodiment;

FIG. 8 shows a data example of a pattern having a strong nonlinearity;

FIG. 9 shows a result of a recognition experiment in each identification method;

FIG. 10 is a graph of weighting factors with respect to eigenvectors in the conventional method;

FIG. 11 is a diagram showing results of experiments made, by varying parameters, on mean degree of similarity between dictionaries in a constrained mutual subspace method;

FIG. 12 is a graph of weighting factors of the embodiments of the invention;

FIG. 13 shows a transition of a recognition rate in a case of carrying out a recognition with a portion with small eigenvalues given a weight of 0; and

FIG. 14 shows a transition of a recognition rate in a case of carrying out a recognition with, in addition to the portion of small eigenvalues, a portion of large eigenvalues given a weight of 0.

### DETAILED DESCRIPTION OF THE INVENTION

Hereafter, embodiments of the invention will be described with reference to the drawings but, before that, a description will be given of a concept of the invention.

### Concept of the Invention

A description will be given of problems of the conventional methods, with reference to FIGS. 10 and 11.

JP-A-2000-30065 (Kokai) and JP-A-2006-221479 (Kokai) disclose a technique which obtains a transformation matrix by projection matrices generated from the dictionary subspaces. Taking that ψᵢⱼ is a jth orthonormal base vector of a dictionary subspace of the ith category, and Nc a number of base vectors of the dictionary subspace, projection matrix Pᵢ is defined by Equation (2).

In the technique of JP-A-2000-30065 (Kokai), by projecting the original feature space onto a feature space called a constrained subspace, an identification is carried out with the dictionary subspaces made as dissimilar as possible. A constrained subspace O_{CMSM} is defined by Equation (4) using the projection matrix of each category.

$$\begin{matrix}{P}_{i} = {\sum }_{j = 1}^{{N}_{C}} {ψ}_{ij} {ψ}_{ij}^{T} & ( 2 ) \\ P = \frac{1}{R} ( {P}_{1} + {P}_{2} + … + {P}_{R} ) & ( 3 ) \\ {O}_{CMSM} = {\sum }_{k = 1}^{{N}_{B}} {φ}_{k} {φ}_{k}^{T} & ( 4 )\end{matrix}$$

where R represents a number of dictionary subspaces, φₖ a kth eigenvector selected counting from small eigenvalues upwards in a matrix P, and N_{B} a number of eigenvectors of the matrix P.

However, in the constrained subspace O_{CMSM} of Equation (4), it is not possible to completely orthogonalize all the dictionary subspaces. When performing an experiment in a face recognition apparatus, it has been confirmed that degree of similarity between dictionary subspaces linearly transformed using the constrained subspace is 0.4, which is about 50 degrees when converted into angular terms, the dictionary subspaces thus not orthogonalized.

JP-A-2006-221479 (Kokai) discloses a technique which generates a transformation matrix orthogonalizing the dictionary subspaces. A transformation matrix O_{OMSM} is defined by Equation (7).

$$\begin{matrix}{P}_{i} = {\sum }_{j = 1}^{{N}_{C}} {ψ}_{ij} {ψ}_{ij}^{T} & ( 5 ) \\ P = \frac{1}{R} ( {P}_{1} + {P}_{2} + … + {P}_{R} ) & ( 6 ) \\ {O}_{OMSM} = {B}_{P} {Λ}_{P}^{- \frac{1}{2}} {B}_{P}^{T} & ( 7 )\end{matrix}$$

where ψᵢⱼ represents a jth orthonormal base vector of a dictionary subspace of an ith category, N_{C} a number of base vectors of the dictionary subspace, R a number of dictionary subspaces, B_{P} a matrix in which eigenvectors of P are arrayed, and Λ_{P} a diagonal matrix of eigenvalues of P. Hereafter, the transformation matrix for the orthogonalization will be referred to as an orthogonalization matrix, and a mutual subspace method using the orthogonalization matrix as an “orthogonal mutual subspace method.” The orthogonalization matrix is referred to mathematically as a whitening matrix.

Herein, considering from the point of view of a projection matrix projected onto a constrained space in the constrained mutual subspace method of JP-A-2000-30065 (Kokai), and an orthogonalization space in the orthogonal mutual subspace method of JP-A-2006-221479 (Kokai), from a perspective of the transformation matrix, respective factors used in the eigenvectors of P are different.

Referring to FIG. 10, the horizontal axis represents numbers of eigenvectors arrayed in descending order of eigenvalues, and the vertical axis represents factors with respect to the individual eigenvectors. In the constrained mutual subspace method (CMSM), the weighting factors up to a certain eigenvalue are 0.0, and those of the others are 1.0. Meanwhile, in the orthogonal mutual subspace method (OMSM), as the weighting factors are reciprocals of eigenvalues, they become larger toward the right as in the graph.

As will also be appreciated from FIG. 10, as weighting factors in a portion of small eigenvalues are large, that effect is great in comparison with the conventional constrained mutual subspace method.

In FIG. 11, an experiment has been performed, using facial image data, as to how similarities between dictionaries are changed in a case of changing a projection dimensionality N_{B}, and the similarity degrees have been obtained by the constrained mutual subspace method. The horizontal axis represents N_{B}, and the vertical axis represents the degree of similarity between the dictionaries. The upper side represents a mean similarity between identical persons (error bars represent a maximum similarity and a minimum similarity degree). The lower side represents the mean degree of similarity between different persons. FIG. 11 shows that a separation of the dictionaries is worsened only in a portion in which eigenvalues are small. In this case, regarding the orthogonal mutual subspace method in which the weight of the portion in which the eigenvalues are small becomes larger, there is a problem in that the identification accuracy deteriorates.

Next, a description will be given of contents of embodiments of the invention, with reference to FIGS. 12 to 14.

As heretofore described, with the conventional methods, regarding the orthogonal mutual subspace method in which the weight of the portion in which the eigenvalues are small increases, there is the problem of the identification accuracy deteriorating.

Therein, in the embodiments of the invention, as shown in FIG. 12, a weighting factor of 0.0 is imparted to a portion of small eigenvalues. That is, a matrix, in which some of diagonal components of a matrix of P, specifically, several of small eigenvalues are replaced with 0, is prepared for this orthogonalization matrix, and the modified orthogonalization matrix (whitening matrix) is taken to be a “pseudo whitening matrix O_{PWMSM}.”

Then, by carrying out a calculation with the orthogonalization matrix O_{OMSM} of the orthogonal mutual subspace method replaced by the pseudo whitening matrix O_{PWMSM}, it is possible to improve results with an applied example which heretofore have not been improved by the orthogonal mutual subspace method.

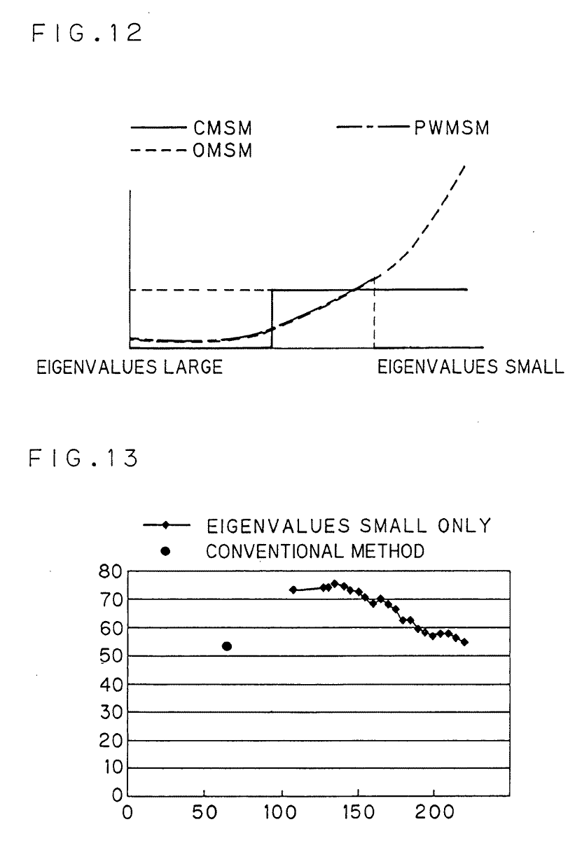

FIG. 13 represents an improvement in a recognition rate in a case where factors of a portion of large eigenvalues are replaced with 0. The horizontal axis represents start positions (100 to 225) of vectors to be replaced, and the vertical axis a recognition accuracy rate. It turns out that the recognition rate has been improved in comparison with a result (the center of the figure) of the conventional orthogonal subspace method.

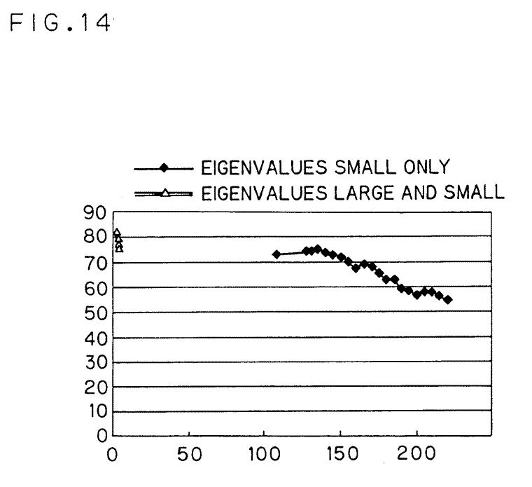

Also, in the same way, FIG. 14 shows an example of a case where, in addition to the factors in the portion of large eigenvalues, factors in a portion of small eigenvalues are also replaced with 0. This is considered to have a similar advantage as in the case where the recognition rate is improved by setting the weighting factors in the portion of large eigenvalues to 0.0, as shown in the constrained mutual subspace method. The upper left graph represents the improvement in the recognition rate.

Hereafter, in the first embodiments, exemplifying a facial image recognition which is one of pattern recognitions will be explained. In a first embodiment, a personal recognition is carried out by a pseudo whitening mutual subspace method when a facial image is input. In a second embodiment, a method of generating a pseudo whitening matrix used in the pseudo whitening mutual subspace method will be explained.

### FIRST EMBODIMENT

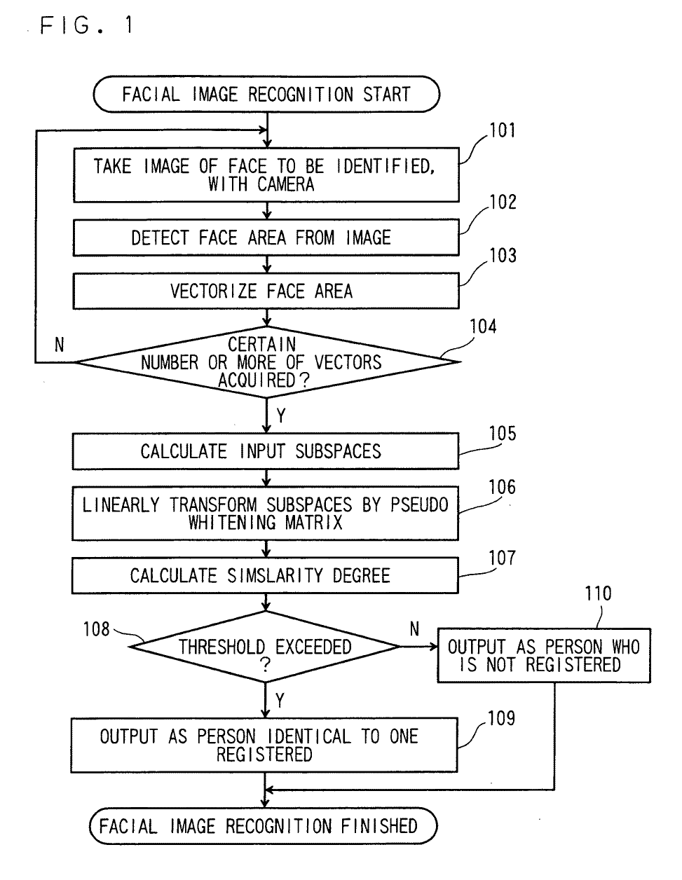

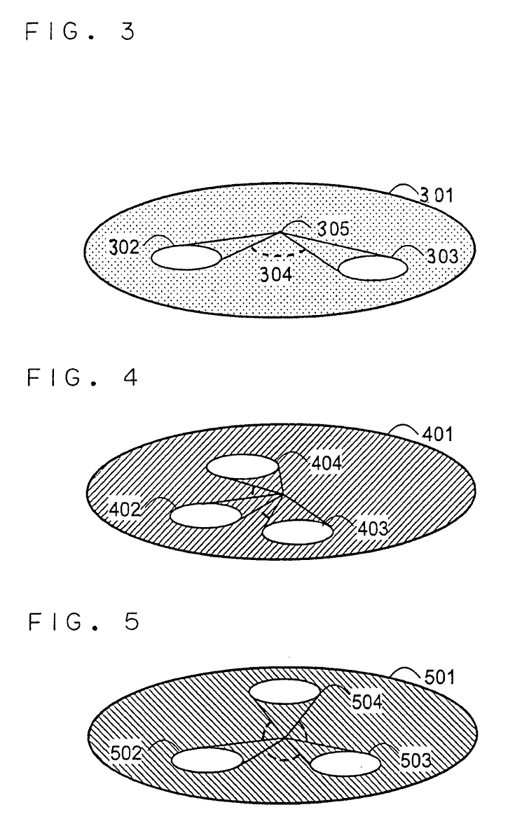

A facial image recognition apparatus 200 of the first embodiment will be explained, with reference to FIGS. 1 to 5.

The facial image recognition apparatus 200 of the embodiment carries out a personal authentication by a pseudo orthogonal mutual subspace method when a facial image is input.

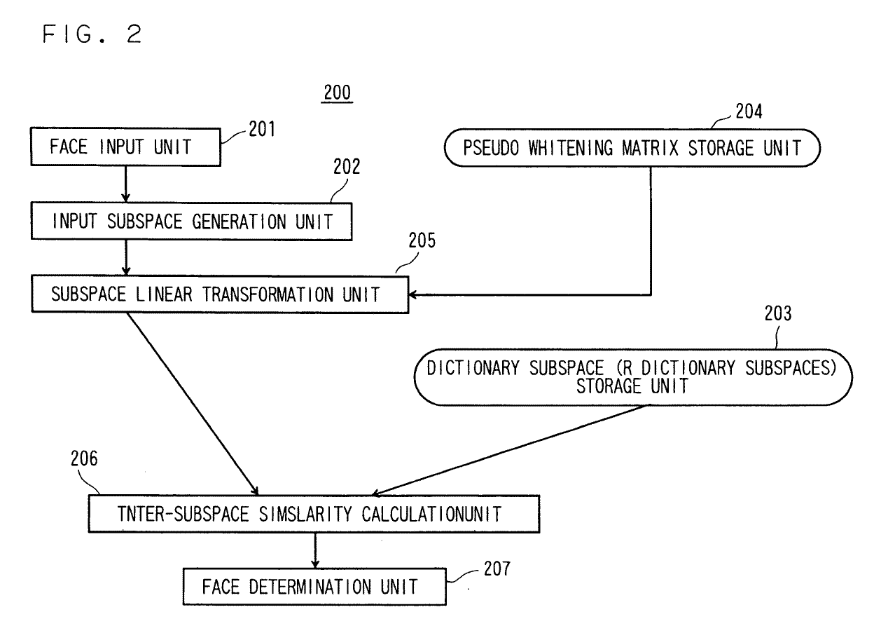

FIG. 2 is a block diagram of the facial image recognition apparatus 200. As shown in FIG. 2, the facial image recognition apparatus 200 includes a face input unit 201, an input subspace generation unit 202, a dictionary subspace storage unit 205, a pseudo whitening matrix storage unit 204, a subspace linear transformation unit 203, an inter-subspace similarity degree calculation unit 206 and a face determination unit 207.

A function of each of the unit 201 to 207 can also be realized by a program stored in a computer readable medium, which causes a computer to perform the following process.

FIG. 1 is a flowchart showing a process of the facial image recognition apparatus 200.

The face input unit 201 inputs a facial image of a person to be taken by a camera (step 101), clips a face area pattern from the image (step 102), and transforms vectors by raster scanning the face area pattern (step 103 of FIG. 1).

The face area pattern can be determined by a positional relationship of extracted facial feature points such as pupils and nostrils. Also, by temporally continuously acquiring facial images, it is possible to constantly acquire patterns to be recognized.

The input subspace generation unit 202, when a predetermined number of vectors are acquired in the face area pattern (step 104), generates input subspaces by a principal component analysis (step 105).

Taking each vector as xᵢ (i=1 to N), a correlation matrix C is represented by

$$C = \frac{1}{N} {\sum }_{k = 1}^{N} {x}_{i} {x}_{i}^{T} .$$

Applying the KL expansion to the correlation matrix C,

C=ΦΛΦ^{T}

is obtained and, taking a row vector of each Φ to be an eigenvector, several eigenvectors are selected in descending order of corresponding eigenvalues, and used as bases of the subspaces.

A number R of dictionary subspaces are stored in the dictionary subspace storage unit 205. One dictionary subspace represents an individual face according to how one person's face is seen. Dictionary subspaces of a person which carry out a personal authentication through the system are registered in advance.

A pseudo whitening matrix O_{PWMSM} which linearly transforms the registered dictionary subspaces is stored in the pseudo whitening matrix storage unit 204. Hereafter, O_{PWMSM} will be expressed as O for simplification of description. A method of generating the pseudo whitening matrix will be described in the second embodiment.

The subspace linear transformation unit 203 linearly transforms a feature space by the pseudo whitening matrix O stored in the pseudo whitening matrix storage unit 204. This allows to linearly transform the original feature space into a feature space in which angles formed by the dictionary subspaces become larger.

Specifically, the R dictionary subspaces stored in the dictionary subspace storage unit 205 and the input subspaces are linearly transformed (step 106). A procedure of the linear transformation will be shown hereafter.

The pseudo whitening matrix O is applied to N base vectors ψᵢ (i=1 . . . N), which define the dictionary subspaces, by Equation (8).

Oψᵢ= ψ̅ᵢ (8)

A length of a vector ψ̅ᵢ after the linear transformation being normalized to 1, the Gram-Schmidt orthogonalization is applied to a number N of normalized vectors. The orthogonalized N normalized vectors become the base vectors of the linearly transformed dictionary subspaces. The input subspaces are also linearly transformed according to the same procedure.

The inter-subspace similarity calculation unit 206 calculates R degrees of similarity between the R dictionary subspaces and the input subspaces, which have been linearly transformed, by a mutual subspace method (step 107).

The input subspaces linearly transformed by the pseudo whitening matrix in the subspace linear transformation unit 206 are taken as P, and the dictionary subspaces, transformed in the same way, as Q. A degree of similarity S between P and Q is determined in Equation (9) based on an angle θ₁, called a canonical angle, which is formed by two subspaces, by the mutual subspace method, previously described.

S=cos² θ₁ (9)

cos² θ₁ becomes a maximal eigenvalue λₘₐₓ of a matrix X below.

$$\begin{matrix}Xa = λ a & ( 10 ) \\ X = ( {x}_{mn} ) ( m , n = 1 … N ) & ( 11 ) \\ {x}_{mn} = {\sum }_{l = 1}^{N} ( {ψ}_{m} , {φ}_{l} ) ( {φ}_{l} , {ψ}_{n} ) & ( 12 )\end{matrix}$$

where ψₘ and φ₁ represent mth and 1st orthonormal base vectors of the subspaces P and Q, (ψₘ, φ₁) an inner product of ψₘ and φ₁, and N a number of base vectors of the subspaces.

In a case where the highest of the R similarity degrees calculated by the inter-subspace similarity calculation unit 206, is higher than a predetermined threshold value, the face determination unit 207 outputs a person corresponding to a dictionary subspace which has been calculated to have that similarity degree, as a person to whom the input facial image belongs.

In other cases, the face determination unit 207 outputs the person as a person not registered in the dictionary subspace storage unit 205.

### SECOND EMBODIMENT

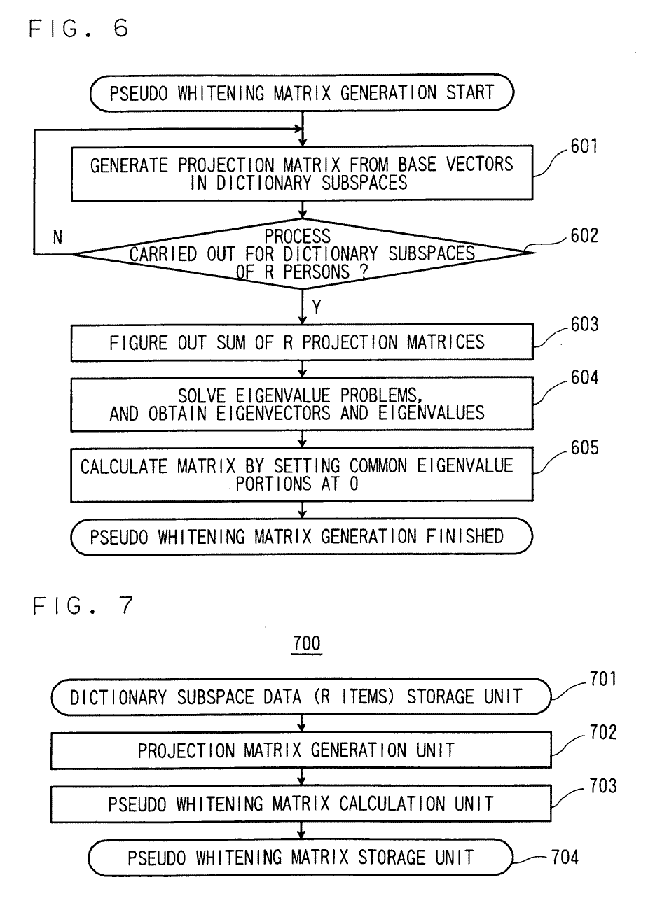

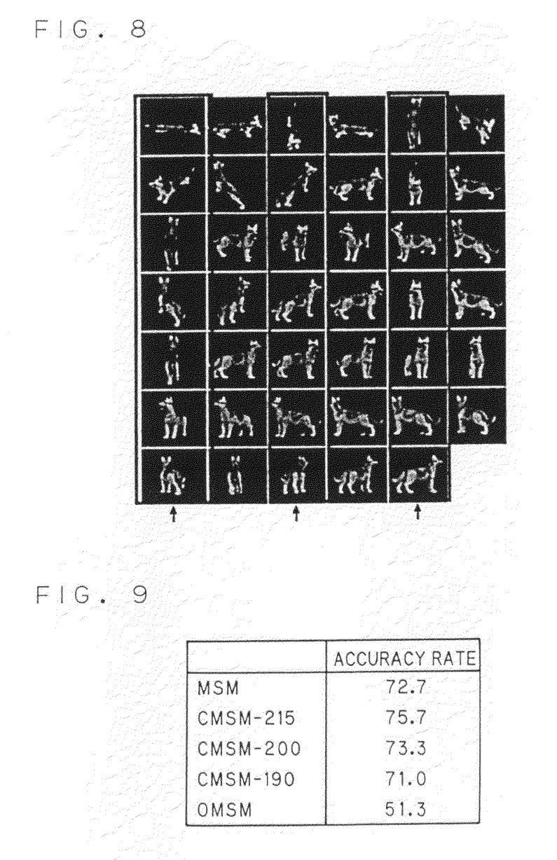

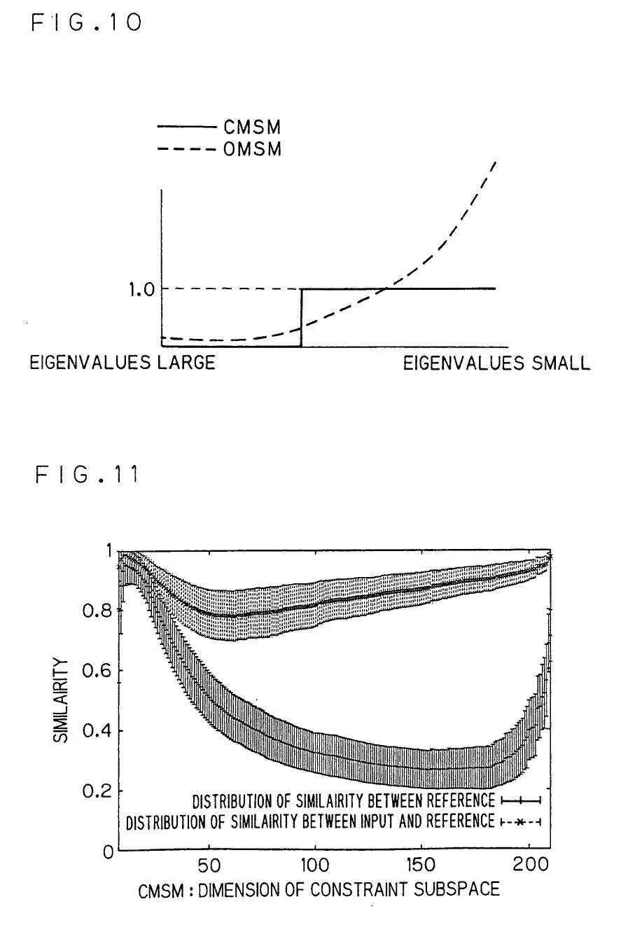

Next, a pseudo whitening matrix generation apparatus 700 of the second embodiment will be explained with reference to FIGS. 6 and 7.

The pseudo whitening matrix generation apparatus 700 of this embodiment generates the pseudo whitening matrix used in the pseudo orthogonal mutual subspace method in the first embodiment.

FIG. 7 is a block diagram of the pseudo whitening matrix generation apparatus 700.

As shown in FIG. 7, the pseudo whitening matrix generation apparatus 700 of this embodiment generates a dictionary subspace storage unit 701, a projection matrix generation unit 702, a pseudo whitening matrix calculation unit 703 and a pseudo whitening matrix storage unit 704.

A function of each of the unit 701 to 704 can also be realized by a program stored in the computer readable medium, which causes a computer to perform the following process.

By utilizing the projection matrices of the dictionary subspaces, generated by the projection matrix generation unit 702, in the pseudo whitening matrix calculation unit 703 to generate a pseudo whitening matrix, it is possible to have the advantage of JP-A-2000-30065 (Kokai). When generating the pseudo whitening matrix in the pseudo whitening calculation unit 703, eigenvalues are also utilized in addition to eigenvectors.

Hereafter, a description will be given, with reference to the flowchart of FIG. 6.

R dictionary subspaces are stored in the dictionary subspace storage unit 701.

Each of the dictionary subspaces may be generated by the input subspace generation unit 202. That is, when a predetermined number of vectors are acquired, the dictionary subspaces may be subspaces by a principal component analysis and take the subspaces to be.

The projection matrix generation unit 702 generates a projection matrix of an ith dictionary subspace, stored in the dictionary subspace storage unit 701, by Equation (13) (step 601).

$${P}_{i} = {\sum }_{j = 1}^{N} {ψ}_{ij} {ψ}_{ij}^{T} \qquad ( 13 )$$

where ψᵢⱼ represents a jth orthonormal base vector of a dictionary subspace of an ith category, and N a number of base vectors of the subspace. A projection matrix generation is repeated a number of times equivalent to the number R of dictionary subspaces stored in the dictionary subspace storage unit 701 (step 602).

The pseudo whitening matrix calculation unit 703 firstly obtains a sum matrix P of R projection matrices, generated by the projection matrix generation unit 702, by Equation (14) (step 603).

$$P = \frac{1}{R} ( {P}_{1} + {P}_{2} + … + {P}_{R} ) \qquad ( 14 )$$

Next, the pseudo whitening matrix calculation unit 703 calculates eigenvalues and eigenvectors of P (step 604). The orthogonalization matrix O used thus far in the orthogonal mutual subspace method is defined by Equation (15).

O=B_{P}Λ_{P}^{-1/2}B_{P}^{T} (15)

where B_{P} is a matrix in which eigenvectors are arrayed, and Λ_{P} a diagonal matrix of the eigenvalues.

Now, Λ_{P} is defined as in Equation (16).

$${Λ}_{p} = ( \begin{matrix}{λ}_{1} & & & & & & & & \\ & {λ}_{2} & & & & & & & \\ & & {λ}_{3} & & & & 0 & & \\ & & & ⋱ & & & & & \\ & & & & ⋱ & & & & \\ & & 0 & & & ⋱ & & & \\ & & & & & & {λ}_{n - 2} & & \\ & & & & & & & {λ}_{n - 1} & \\ & & & & & & & & {λ}_{n}\end{matrix} ) \qquad ( 16 )$$

Now, Λ′_{P}, in which several of the larger eigenvalues of Λ_{P} are replaced with 0, is defined as in Equation (17).

$${Λ}_{p}^{′} = ( \begin{matrix}0 & & & & & & & & \\ & 0 & & & & & & & \\ & & {λ}_{k} & & & & 0 & & \\ & & & ⋱ & & & & & \\ & & & & ⋱ & & & & \\ & & 0 & & & ⋱ & & & \\ & & & & & & {λ}_{n - 2} & & \\ & & & & & & & {λ}_{n - 1} & \\ & & & & & & & & {λ}_{n}\end{matrix} ) \qquad ( 17 )$$

A pseudo whitening matrix H is defined by Equation (18), and R matrices are calculated (step 605 of FIG. 6).

H=B_{P}Λ′_{P}^{-1/2}B_{P}^{T} (18)

As for Λ′_{P}, it is also acceptable to use one in which a portion in which eigenvalues are small is set to 0, as in Equation (19), or one in which both portions of large and small eigenvalues in Equation (20) are set to 0.

$$\begin{matrix}{Λ}_{p}^{′} = ( \begin{matrix}{λ}_{1} & & & & & & & & \\ & {λ}_{2} & & & & & & & \\ & & {λ}_{3} & & & & 0 & & \\ & & & ⋱ & & & & & \\ & & & & ⋱ & & & & \\ & & 0 & & & ⋱ & & & \\ & & & & & & {λ}_{m} & & \\ & & & & & & & 0 & \\ & & & & & & & & 0\end{matrix} ) & ( 19 ) \\ {Λ}_{p}^{′} = ( \begin{matrix}0 & & & & & & & & \\ & 0 & & & & & & & \\ & & {λ}_{k} & & & & 0 & & \\ & & & ⋱ & & & & & \\ & & & & ⋱ & & & & \\ & & 0 & & & ⋱ & & & \\ & & & & & & {λ}_{m} & & \\ & & & & & & & 0 & \\ & & & & & & & & 0\end{matrix} ) . & ( 20 )\end{matrix}$$

The pseudo whitening matrix storage unit 704 stores the generated pseudo whitening matrix H.

A transformation using the pseudo whitening matrix can be replaced with the transformation using the normalization matrix which has heretofore been carried out in the orthogonal mutual subspace method.

For example, in a case of multiple transformations using a plurality of orthogonalization matrices, it is also acceptable to make some of them the pseudo whitening matrices. Also, regarding a nonlinear orthogonal mutual subspace method which is a nonlinearized orthogonal mutual subspace method, the pseudo whitening matrix may be used.

The invention not being limited to each heretofore described embodiment, it is possible to make various modifications without departing from its scope.

For example, the invention not being limited to the facial image, it is also possible to use letters, sound, fingerprints and the like as patterns.

What is claimed is:

1. A pattern recognition apparatus, comprising:
an input subspace calculation unit which calculates an input subspace from a plurality of input patterns;
a dictionary subspace calculation unit which calculates a dictionary subspace from a plurality of dictionary patterns each dictionary pattern belonging to one of the plurality of categories;
an eigenvalue calculation unit which calculates a plurality of eigenvalues and a plurality of eigenvectors based on a sum matrix of projection matrices concerning the dictionary subspaces;
a diagonal matrix generation unit which generates a diagonal matrix having diagonal components equivalent to a number sequence in which at least one of the plurality of eigenvalues are replaced with 0;
a transformation matrix calculation unit which, using the diagonal matrix and the plurality of eigenvectors, calculates a pseudo whitening matrix representing a linear transformation having a property of reducing a degree of similarity between the dictionary subspaces;
a transformation unit which, using the pseudo whitening matrix, linearly transforms the input subspaces and the dictionary subspaces;
a similarity degree calculation unit which calculates degrees of similarity between the linearly transformed input subspaces and the linearly transformed dictionary subspaces; and
a recognition unit which, based on the similarity degrees, recognizes which of the plurality of categories each of the plurality of input patterns belongs to.

2. The apparatus according to claim 1, wherein
the diagonal matrix generation unit generates the diagonal matrix having the diagonal components equivalent to a sequence in which at least one of the plurality of eigenvalues in order from the largest is replaced with 0.

3. The apparatus according to claim 1, wherein
the diagonal matrix generation unit generates the diagonal matrix having the diagonal components equivalent to a sequence in which at least one of the plurality of eigenvalues in order from the smallest is replaced with 0.

4. The apparatus according to claim 1, wherein
the diagonal matrix generation unit generates the diagonal matrix having the diagonal components equivalent to a sequence in which at least one of the plurality of eigenvalues in order from the largest is replaced with 0, and at least one of the plurality of eigenvalues in order from the smallest is replaced with 0.

5. A pattern recognition method, comprising:
calculating an input subspace from a plurality of input patterns;
calculating a dictionary subspace from a plurality of dictionary patterns, each dictionary pattern belonging to one of the plurality of categories;
calculating a plurality of eigenvalues and a plurality of eigenvectors based on a sum matrix of projection matrices concerning the dictionary subspaces;
generating a diagonal matrix having diagonal components equivalent to a sequence in which at least one of the plurality of eigenvalues are replaced with 0;
calculating, using the diagonal matrix and the plurality of eigenvectors, a pseudo whitening matrix representing a linear transformation having a property of reducing a degree of similarity between the dictionary subspaces;
transforming, using the pseudo whitening matrix, the input subspaces and the dictionary subspaces linearly;
calculating degrees of similarity between the linearly transformed input subspaces and the linearly transformed dictionary subspaces; and
recognizing, based on the similarity degrees, which of the plurality of categories each of the plurality of input patterns belongs to.

6. A program, stored in a computer readable medium, which which causes a computer to perform:
calculating input subspaces from a plurality of input patterns;
calculating dictionary subspaces from dictionary patterns, each of the dictionary patterns respectively corresponding to a plurality of categories;
calculating a plurality of eigenvalues and a plurality of eigenvectors based on a sum matrix of projection matrices concerning the dictionary subspaces;
generating a diagonal matrix having diagonal components equivalent to a sequence in which some of the plurality of eigenvalues are replaced with 0;
calculating, using the diagonal matrix and the plurality of eigenvectors, a pseudo whitening matrix representing a linear transformation having a property of reducing a degree of similarity between the dictionary subspaces;
transforming, using the pseudo whitening matrix, the input subspaces and the dictionary subspaces linearly;
calculating degrees of similarity between the linearly transformed input subspaces and the linearly transformed dictionary subspaces; and
recognizing, based on the similarity degrees, which of the plurality of categories each of the plurality of input patterns belongs to.
